(19) United States
(12) Patent Application Publication
(10) Pub. No.: US 2022/0338314 A1
(43) Pub. Date: Oct. 20, 2022

(54) INDUCTION ENERGY TRANSMISSION SYSTEM

(71) Applicant: BSH Hausgeräte GmbH, Munich (DE)

(72) Inventors: Tomas Cabeza Gozalo, Zaragoza (ES); Javier Lasobras Bernad, EJEA DE LOS CABALLEROS (ZARAGOZA) (ES); Sergio Llorente Gil, Zaragoza (ES); Emilio Plumed Velilla, Zaragoza (ES); Julio Rivera Peman, Cuarte de Huerva (Zaragoza) (ES)

(21) Appl. No.: 17/641,110

(22) PCT Filed: Sep. 23, 2020
(86) PCT No.: PCT/EP2020/076522

§ 371 Date: Mar. 8, 2022

(30) Foreign Application Priority Data
Oct. 8, 2019 (EP) 19382877

(51) Int. Cl. H05B 6/12; H05B 6/06; H02J 50/10

(52) U.S. Cl. CPC H05B 6/1236; H05B 6/062; H02J 50/10

(57) ABSTRACT

An induction energy transmission system includes a receiving unit having a first receiving induction element for receiving an inductively provided energy, and a voltage converter unit connected to the first receiving induction element and configured to convert an electrical voltage of the first receiving induction element for supply of energy to an additional unit.

The invention relates to an induction energy transmission system, in particular an induction cooking system, as claimed in the preamble of claim 1 and a method for operating an induction energy transmission system, in particular an induction cooking system, as claimed in the preamble of claim 14.

An induction energy transmission system is already known from the prior art, said induction energy transmission system having a supply unit which is configured as a hob with a plurality of supply induction elements, which in an operating state provide energy to a receiving unit which is configured as an item of cookware. The receiving unit is part of the induction energy transmission system and has a plurality of receiving induction elements. In the operating state, the receiving induction elements receive energy from the supply induction elements and supply an additional unit of the receiving unit with a part of the energy received by the supply induction elements.

The object of the invention is, in particular, to provide a generic system having improved properties with regard to supplying energy. The object is achieved by the features of claims 1 and 14, while advantageous embodiments and developments of the invention may be derived from the subclaims.

The invention is based on an induction energy transmission system, in particular an induction cooking system, and advantageously an induction hob-type cooking system, comprising at least one receiving unit, which has at least one receiving induction element for receiving an inductively provided energy.

It is proposed that the receiving unit has at least one voltage converter unit connected to the receiving induction element, which voltage converter unit is provided for converting a voltage of the receiving induction element in order to supply energy to at least one additional unit.

Advantageously an optimized energy supply, in particular to the additional unit, may be achieved by means of the embodiment according to the invention. In particular, a high level of user convenience may be achieved and namely, in particular, relative to a high operational efficiency and/or an optimized energy supply to the additional unit. A voltage used and/or provided for supplying energy to the additional unit may be converted by the voltage converter unit and in particular increased, whereby the additional unit may be operated in particular in a voltage range which is optimized and/or which is tailored to the additional unit. An overload, in particular of the receiving induction element and/or at least one voltage regulator of the receiving unit, may be avoided, in particular, whereby in particular an operationally efficient and/or long-lasting embodiment may be achieved. In particular, a low probability of a defect in the additional unit may be made possible. In particular, a high level of efficiency may be made possible. In particular, low electrical losses may be achieved.

An “induction energy transmission system”, in particular an “induction cooking system” and advantageously an “induction hob-type cooking system” is intended to be understood to mean, in particular, a system which has a main function in the form of transmitting energy and/or receiving energy. In this case, the induction energy transmission system could be configured as an item of cookware or a support unit for positioning an item of cookware. The induction energy transmission system, however, may also additionally have, in addition to the receiving unit, at least one supply unit, in particular at least one induction cooking appliance and advantageously at least one induction hob. The supply unit has, in particular, at least one supply induction element which, in particular in at least one operating state, provides energy in particular for the purpose of transmitting energy to the receiving unit. For example, the induction energy transmission system could be configured as an induction hand-held power tool system. In particular, the supply unit and/or the receiving unit could be configured as a hand-held power tool, such as for example a drill and/or an electric screwdriver and/or a hammer drill and/or a saw. Alternatively or additionally, the supply unit and/or the receiving unit could be configured as a transformer. The induction energy transmission system could be provided for at least one self-propelled implement and/or for at least one remote control unit and/or for at least one remote operation unit. In particular, the receiving unit could be configured as a self-propelled implement and/or as a remote control unit and/or as a remote operation unit. The self-propelled implement could be configured, for example, as a self-propelled mower and/or as a self-propelled vacuum cleaner. The remote control unit and/or the remote operation unit could be provided, in particular, for an operation and/or for a control of at least one blind and/or at least one electrical appliance, in particular at least one household electrical appliance, and/or at least one model object, such as for example a model automobile and/or a model aircraft and/or a model boat. Moreover, the receiving unit of the induction energy transmission system could be configured as a means of transportation, in particular as an electric motor vehicle or a hybrid motor vehicle or as an electric bicycle or as an electric scooter or as another fully or partially electrically operated means of transportation. Preferably, the induction energy transmission system is configured as an induction cooking system. For example, the induction energy transmission system could be configured as an induction oven system and/or as an induction grill system. In particular, the supply unit and/or the receiving unit could be configured as an induction oven and/or as an induction grill. Advantageously, the induction energy transmission system is configured as an induction hob-type cooking system. The supply unit and/or the receiving unit is configured, in particular, as an induction hob.

A “receiving unit” is intended to be understood to mean, in particular, a unit which in at least one operating state receives energy, in particular inductively, and which in particular has at least one main function. The receiving unit could have, for example, at least one consumer which, in particular, could be part of the additional unit and which in the operating state, in particular, could consume energy. Alternatively or additionally, the receiving unit could be provided for supplying energy to the additional unit and, in particular, itself be free of a consumer. The receiving unit could be, for example, a hand-held power tool, such as for example a drill and/or an electric screwdriver and/or a hammer drill and/or a saw, and/or an automobile and/or a mobile device, such as for example a laptop and/or a tablet and/or a mobile telephone, and/or a remote control unit and/or a remote operation unit and/or a self-propelled implement. Moreover, the receiving unit could be configured as a means of transportation, in particular as an electric motor vehicle or a hybrid motor vehicle or as an electric bicycle or as an electric scooter or as another fully or partially electrically operated means of transportation. A main function of the receiving unit could include, for example, a drilling and/or a hammering and/or a sawing and/or a screwing and/or a data processing and/or a telephoning and/or a traveling.

In the case of an induction energy transmission system configured as an induction cooking system, a main function of the receiving unit is, in particular, receiving energy. In this case, the receiving unit may be configured as a positioning unit and, in particular, as an item of cookware and/or as a support unit for positioning an item of cookware. A “positioning unit” is intended to be understood to mean, in particular, a unit which is provided for coupling to the supply unit, in particular to the supply induction element, and which in particular in the context of being coupled to the supply unit takes and/or receives energy from the supply unit in at least one operating state. The positioning unit could have, for example, at least one item of cookware. Alternatively or additionally, the positioning unit could have at least one support unit which could be provided, in particular, for positioning at least one item of cookware, in particular the item of cookware. The support unit could be provided, in particular, for an arrangement between the positioning plate and the item of cookware. Alternatively or additionally, the positioning unit could have at least one housing unit which could be configured, in particular, as an external housing unit and, in particular, could define an external housing. In particular, at least one object of the positioning unit, in particular at least the receiving induction elements and/or the additional unit and/or the further receiving induction element and/or the control unit, could be integrated at least partially and advantageously at least to a large part in the housing unit. In particular, in the operating state at least one of the receiving induction elements could heat a wall, which defines the receiving space at least in some sections, by means of at least one part of the energy received by the supply induction element. Alternatively or additionally, in the operating state the supply induction element could directly heat a wall, which defines the receiving space at least in some sections, in particular by means of the energy provided by the supply induction element. A “receiving space” is intended to be understood to mean, in particular, a spatial region which in the operating state in which the supply unit, in particular, transmits energy to the receiving unit, is defined at least to a large part by the receiving unit and in which, in particular, food may be arranged in the operating state. The food could be arranged, in particular, in fluid form, in particular in liquid form and/or at least to a large part in liquid form, and/or in solid form in the receiving space. Food may be cooked, in particular, in a particularly efficient and/or targeted manner thereby, since in particular an energy required for a cooking may be accurately transmitted.

For example, in the operating state the energy received by the receiving unit could be converted, in particular directly, into at least one further energy form, such as for example into heat. The receiving unit could have, for example, at least two, in particular at least three, advantageously at least four, particularly advantageously at least five, preferably at least eight and particularly preferably a plurality of receiving induction elements which, in particular in the operating state, in each case could receive energy inductively, in particular from the supply induction element.

A “supply unit” is intended to be understood to mean, in particular, a unit which in at least one operating state provides energy inductively and which, in particular, has a main function in the form of providing energy. For providing energy the supply unit has, in particular, at least one supply induction element which, in particular, has at least one coil, in particular at least one primary coil, and which provides energy inductively, in particular in the operating state.

An “induction element” is intended to be understood to mean, in particular, an element which in at least one operating state provides and/or receives energy, in particular for the purpose of transmitting energy inductively. In particular, in the operating state an induction element configured as a supply induction element provides energy, in particular, for the purpose of transmitting energy inductively. The supply induction element could have, in particular, at least one coil, in particular at least one primary coil, which could be provided, in particular, for transmitting energy inductively to at least one secondary coil. The secondary coil, for example, could be part of the receiving unit, in particular at least of a receiving induction element of the receiving unit. In particular, in the operating state an induction element configured as a receiving induction element receives energy, in particular for the purpose of transmitting energy inductively and namely in particular from the supply induction element. At least one of the receiving induction elements could have, in particular, at least one coil, in particular at least one secondary coil, which could be provided in particular for receiving energy inductively from the supply induction element.

The supply induction element could be configured, for example, as a transformer element, i.e. in particular as a part of a transformer. Alternatively or additionally, the supply induction element could be configured, in particular, as an induction heating element and could be provided, in particular, for transmitting energy to at least one receiving unit configured as a positioning unit, in particular for the purpose of heating at least one part of the positioning unit. In at least one operating state the supply induction element could provide, in particular, an alternating field, in particular an electromagnetic alternating field, with a frequency of at least 1 Hz, in particular of at least 2 Hz, advantageously of at least 5 Hz and preferably of at least 10 Hz. In particular, in at least one operating state the supply induction element could provide, in particular, an alternating field, in particular an electromagnetic alternating field, with a frequency of a maximum of 150 kHz, in particular of a maximum of 120 kHz, advantageously of a maximum of 100 kHz and preferably of a maximum of 80 kHz. A supply induction element configured, in particular, as an induction heating element could provide in at least one operating state, in particular, a high-frequency alternating field, in particular a high-frequency electromagnetic alternating field, with a frequency of at least 15 kHz and in particular of a maximum of 100 kHz.

For example, the supply unit could have exactly one supply induction element. The supply unit could have, for example, at least two, in particular at least three, advantageously at least four, particularly advantageously at least five, preferably at least eight and particularly preferably a plurality of supply induction elements which could provide, in particular in the operating state, in each case energy inductively and namely in particular to an, in particular, single receiving unit or to at least two receiving units. In particular one, in particular any one of the supply induction elements could be arranged, in particular, in the vicinity of at least one further supply induction element. At least some of the supply induction elements could be arranged, for example, in a row and/or in the form of a matrix. In particular, at least some of the supply induction elements could be arranged so as to be at least partially overlapping, in particular when viewed perpendicular to a main extension plane of at least one of the supply induction elements which are arranged so as to be overlapping.

A “voltage converter unit” is intended to be understood to mean, in particular, an electronic subassembly which is provided for a conversion of at least one input voltage, in particular of at least one first effective voltage, into at least one output voltage which differs in terms of value from the input voltage, in particular at least one second effective voltage which is preferably higher in terms of value than the input voltage. The voltage converter unit preferably has at last one active electric and/or electronic structural element, such as for example a diode and at least one passive electric and/or electronic component, such as for example a capacitor. Preferably, the input voltage is an electrical alternating voltage induced in at least one receiving induction element. In this case, a further main function of the voltage converter unit may be a rectification of the input alternating voltage into at least one pulsing, and preferably into a smoothed, electrical output direct voltage of a first electrical polarity. Alternatively, it is conceivable that the electrical input voltage is an electrical direct voltage. In this case, the receiving unit may comprise at least one rectifier unit which converts an alternating voltage which is electrically induced in the at least one receiving induction element into an electrical direct voltage which is suitable as input voltage for the voltage converter unit.

“Provided” is intended to be understood to mean, in particular, specifically programmed, designed and/or equipped. An object being provided for a specific function is intended to be understood to mean, in particular, that the object fulfills and/or performs this specific function in at least one use state and/or operating state.

The voltage converter unit preferably comprises at least one “voltage cascade” with at least one stage in which at least some of the electrical components of the voltage converter unit are arranged, whereby advantageously an electrical voltage may be converted and, in particular, increased in terms of value and/or rectified by simple technical means, in particular by simple and cost-effective electrical components. A further advantage of a voltage converter unit with at least one voltage cascade results from the fact that in such an embodiment inductive electrical and/or inductive electronic components, such as in particular coils in the voltage converter unit, may be dispensed with, whereby in particular it is possible to supply voltage to the at least one additional unit in a manner which is reliable and less prone to error. Alternatively or additionally, it would be conceivable that the voltage converter unit contains a step-down converter and/or a step-up converter and/or a buck-boost converter. A “voltage cascade” is intended to be understood to mean, in particular, a specific arrangement of electrical components of the voltage converter unit inside an electrical circuit which is provided, in particular, for a conversion and optionally additionally for a rectification of an electrical input voltage. The voltage cascade comprises at least one first stage for a first conversion of an electrical input voltage. Preferably, the voltage cascade comprises at least two and particularly preferably a plurality of, in particular in each case individually activatable, stages for a further, and in particular flexible, conversion of an electrical input voltage. For example, the at least one voltage cascade could be configured as a “Villard circuit” or as a “Greinacher circuit” or as a “Delon circuit” and particular preferably as a “Cockcroft-Walton circuit”, wherein both single-stage and preferably multi-stage arrangements and further expedient modifications of the aforementioned circuit topologies are conceivable. In cases where the electrical input voltage of the voltage converter unit is already present as an electrical direct voltage, it is also conceivable that the at least one voltage cascade is configured as a “charge pump” and in particular as a “Dickson charge pump”, wherein both single-stage and preferably multi-stage arrangements of charge pumps are conceivable.

An “additional unit” is intended to be understood to mean, in particular, an electronic consumer unit which, in particular, may be part of the induction energy transmission system and/or the receiving unit. Alternatively, it would be conceivable that the additional unit is an external unit which may be connected, in particular, directly or indirectly to the receiving unit, for example via a cable or wirelessly. The additional unit, in particular, is different from a control unit. In at least one operating state, the additional unit consumes at least one part of the energy inductively received by the at least one receiving induction element. The additional unit could be, for example, a display unit and/or an output unit and/or a user interface and/or a lighting unit and/or a sensor unit and/or a different consumer unit.

It would be conceivable, for example, that the receiving unit is configured without a control unit and/or a control unit is arranged, for example, outside the receiving unit. It is additionally conceivable that a control unit has a plurality of voltage regulators. Advantageously, the receiving unit has at least one control unit with at least one, and preferably exactly one, voltage regulator which is provided to adjust a supply voltage for the additional unit. As a result, advantageously an at least substantially stable and/or constant voltage, in particular an at least substantially stable and/or constant electrical direct voltage, may be provided for supplying the additional unit.

A “control unit” is intended to be understood to mean, in particular, an electronic unit which is provided, in particular, for a control and/or regulation of at least the receiving induction elements and/or the supply induction elements and/or the additional unit and/or at least one voltage regulator and/or at least one switching unit of the receiving unit. Preferably, the control unit comprises a computing unit and, in particular in addition to the computing unit, a memory unit with at least one control and/or regulating program which is stored therein and which is provided to be executed by the computing unit. For example, the control unit could be part of the supply unit and, in particular, be at least partially integrated in a control and/or regulating unit of the supply unit and preferably configured as a hob control unit. Alternatively, the control unit could be part of an external unit. The external unit could be, in particular, part of the induction energy transmission system and, for example, be a mobile device and/or a computer and/or an external control unit. The mobile device could be, for example, a laptop and/or a tablet and/or a mobile telephone. Preferably, the control unit is part of the receiving unit and, in particular, is integrated at least to a large part in the receiving unit.

A “voltage regulator” is intended to be understood to mean an electrical and/or electronic component which adjusts and, in particular, regulates and/or stabilizes an electrical voltage, in particular an electrical direct voltage. The voltage regulator regulates and/or stabilizes, in particular, an electrical voltage provided by the voltage converter unit, in particular an electrical direct voltage, which is provided in particular as a supply voltage for supplying the at least one additional unit. Preferably, the voltage regulator is configured as a linear regulator, in particular an in-phase regulator and advantageously a low-dropout voltage regulator and comprises, in particular, at least one transistor, preferably a pnp transistor. Alternatively or additionally, a voltage regulator could also be a switching regulator or a transverse regulator or a combination of an in-phase regulator and transverse regulator.

The voltage cascade has at least one stage. In an advantageous embodiment, it is proposed that the voltage cascade has a plurality of stages for a conversion of the electrical voltage and the control unit comprises a switching unit which activates a suitable stage of the at least one voltage cascade as a function of a supply voltage required by the additional unit. As a result, advantageously the additional unit may be operated, in particular, in a voltage range which is optimized and/or which is tailored to the additional unit. In particular, a high level of efficiency may be made possible. In particular, low electrical losses may be achieved.

For example, the receiving unit could have at least one rectifier unit and/or at least one rectifier element. Advantageously, the voltage converter unit is provided to convert at least one electrical alternating voltage into at least one electrical direct voltage. Preferably, a conversion of the electrical alternating voltage which is received inductively by the receiving induction element takes place in the at least one voltage cascade of the voltage converter unit. The first voltage cascade, in particular, converts a first half oscillation of the electrical alternating voltage, which in particular lasts for a first half period of an alternating voltage interval, into an electrical direct voltage of a first electrical polarity, for example a positive electrical polarity. As a result, advantageously a separate electrical rectifier unit may be dispensed with, whereby in particular advantageously a number of sub-assemblies and/or structural elements may be reduced and, in particular, a cost-effective receiving unit may be provided.

In a further embodiment, it is proposed that the voltage converter unit is provided to convert the electrical alternating voltage into a least one further electrical direct voltage with a polarity opposing that of the direct voltage. Preferably, to this end the voltage converter unit has at least one further voltage cascade for a conversion of the electrical alternating voltage which is received inductively by the receiving induction element. The further voltage cascade is advantageously constructed symmetrically to the first voltage cascade and converts a second half oscillation of an electrical alternating voltage, which in particular lasts for a second half period of an alternating voltage interval, into a direct voltage of a second electrical polarity opposing the first electrical polarity, for example a negative electrical polarity. As a result, advantageously it is possible to supply voltage to the at least one additional unit, in particular in an energy-efficient manner. Additionally, as a result, a bipolar and in particular symmetrical direct voltage supply to the at least one additional unit may be made possible.

It is further proposed that the voltage converter unit comprises at least one Cockcroft-Walton circuit. As a result, a conversion of an electrical voltage, in particular an electrical alternating voltage, may be implemented by particularly simple technical means. Advantageously, the voltage converter unit comprises at least one single-stage, preferably at least one two-stage and particularly preferably at least one multi-stage Cockcroft-Walton circuit. Alternatively or additionally, it would be conceivable that the voltage converter unit comprises at least one “Villard circuit” and/or at least one “Greinacher circuit” and/or at least one “Delon circuit”, wherein both single-stage and preferably multi-stage arrangements and further expedient modifications of the aforementioned circuit topologies are conceivable. In cases where the receiving unit additionally has at least one rectifier unit and/or at least one rectifier element which deliver an electrical direct voltage to the voltage converter unit, it is additionally conceivable that the at least one voltage cascade is configured as “charge pump” and in particular as a “Dickson charge pump”, wherein both single-stage and preferably multi-stage arrangements of charge pumps are conceivable.

For example, the receiving unit could have at least one second receiving induction element, wherein the receiving induction elements are part of at least two different secondary coils. Advantageously, it is proposed that the receiving unit has at least one second receiving induction element which is part of a common secondary coil with the first receiving induction element. The receiving induction elements, in particular, are connected electrically in series, wherein each receiving induction element may be switched on or switched off separately. A receiving induction element is switched on and/or switched off by the control unit and, in particular, by the switching unit of the control unit. As a result, an in particular optimal voltage supply may be ensured, in particular to the at least one additional unit. Additionally, in particular a plurality of different secondary coils may be dispensed with, whereby in particular costs, in particular storage costs, may be saved.

It would be conceivable, for example, that the induction energy transmission system comprises the at least one receiving unit, wherein a supply unit is not part of the induction energy transmission system but part of a separate additional system. Such an embodiment would be conceivable in cases, in particular, where the receiving unit of the induction energy transmission system is configured as a means of transportation, in particular as an electric motor vehicle or a hybrid motor vehicle or as an electric bicycle or as an electric scooter or as another fully or partially electrically operated means of transportation, and a supply unit is configured, for example, as a charging station integrated in a parking area and as such is not part of the induction energy transmission system. Advantageously, the induction energy transmission system comprises at least one supply unit which has at least one supply induction element, which is provided for providing a magnetic alternating field for the receiving induction element. As a result, advantageously it is possible to supply energy to the at least one receiving induction element, in particular in an optimized manner. Advantageously, the at least one receiving induction element and the at least one supply induction element may be adapted to one another, in particular optimally, whereby in particular electrical losses may be minimized.

The supply unit could be configured, for example, as a charging unit for inductive charging of at least one mobile device, such as for example a laptop and/or a tablet and/or a mobile telephone, and/or as a charging station for an inductive charging of a means of transportation, in particular an electric motor vehicle and/or an electric bicycle and/or an electric scooter. Preferably, the supply unit is configured as a cooking appliance, in particular as an induction cooking appliance, such as for example as a hob, in particular as an induction hob and/or as an oven, in particular as an induction oven and/or as a grill, in particular as an induction grill. In particular, by means of the energy provided by the supply induction element, the supply unit heats at least one part of the receiving unit, in particular at least one receiving space of the receiving unit. As a result, the receiving unit may be supplied, in particular, with the energy provided for the receiving unit, whereby in particular optimal cooking results and/or a reliable operational efficiency of electrical and/or electronic units integrated in the receiving unit, in particular of the at least one additional unit, may be achieved.

The receiving unit could be configured, for example, as a mobile device, such as for example a laptop and/or a tablet and/or a mobile telephone, and/or as a hand-held power tool and/or as a self-propelled implement and/or as a remote control unit and/or as a remote operation unit. Moreover, the receiving unit could be configured as a means of transportation, such as for example as an electric motor vehicle and/or a hybrid motor vehicle and/or as an electric bicycle and/or an electric scooter and/or as another fully or partially electrically driven means of transportation. In an advantageous embodiment of the present invention, it is proposed that the receiving unit is configured as an item of cookware, in particular as an item of induction cookware. The receiving unit configured as an item of cookware has at least one receiving induction element which is configured as a secondary coil. The receiving induction element supplies at least one electrical heating element, preferably an electrical resistance heating element, with a part of the energy received by the supply induction element. Additionally, the receiving induction element supplies at least one additional unit with a further part of the received energy, wherein the additional unit could be arranged on or in the item of cookware and could be provided, for example, as a sensor unit for measuring at least one operating parameter, for example a temperature. As a result, advantageously at least one food, which is arranged during a cooking process in the receiving space of the item of cookware, may be accurately supplied with the energy provided for one respective cooking process, whereby in particular optimal cooking results may be achieved. Moreover, advantageously at least one additional unit which is arranged on or in the item of cookware may be optimally supplied with energy.

In an alternative advantageous embodiment of the present invention, the receiving unit may be configured as a support unit for positioning an item of cookware. For example, a receiving unit which is configured as a support unit could consist of at least one magnetic, in particular at least one ferromagnetic, material and as a result advantageously, in particular, permit a heating of an item of cookware which is not suitable for induction and/or which is non-magnetic, in particular which is non-ferromagnetic, by means of the energy provided by the supply induction element. Moreover, as a result, advantageously a transmission of heat from the item of cookware to a positioning plate may be at least substantially prevented.

The invention is further based on a method for operating an induction energy transmission system, in particular an induction cooking system, with at least one receiving induction element which in an operating state receives inductively provided energy.

It is proposed that an electrical voltage of the receiving induction element is converted for supplying energy to at least one additional unit. The conversion of the voltage preferably takes place by means of a voltage converter unit connected to the receiving induction element. As a result, advantageously the at least one additional unit in particular may be optimally supplied with energy.

The induction energy transmission system in this case is not intended to be limited to the above-described use and embodiment. In particular, for fulfilling a mode of operation described herein, the induction energy transmission system may have a number of individual elements, components and units deviating from a number cited herein.

Further advantages emerge from the following description of the drawing. Exemplary embodiments of the invention are shown in the drawing. The drawing, the description and the claims contain numerous features in combination. The person skilled in the art will also expediently consider the features individually and combine them together to form further meaningful combinations.

In the drawing:

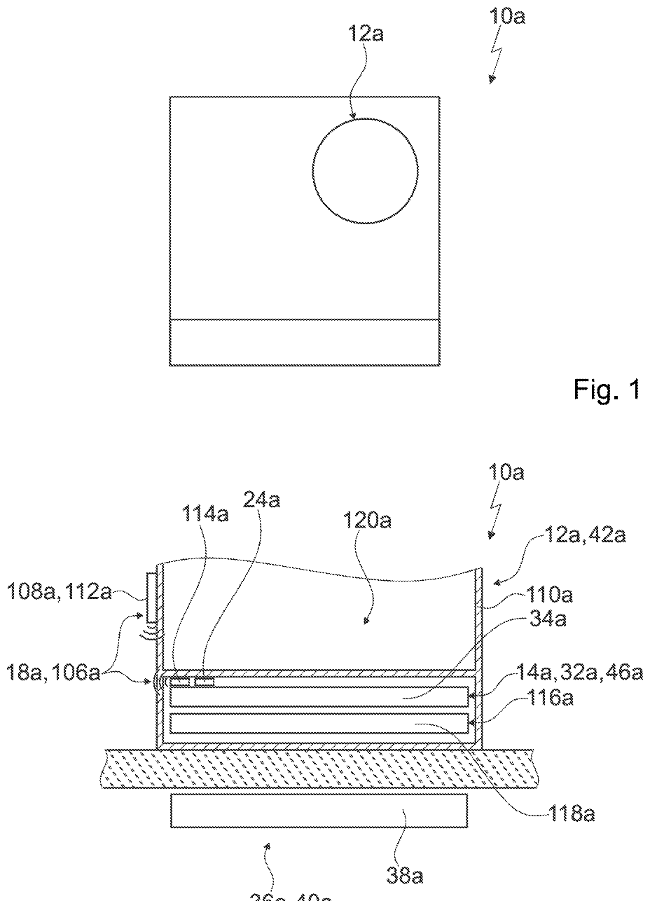

FIG. 1 shows an induction energy transmission system with a receiving unit configured as an item of cookware in a schematic plan view,

FIG. 2 shows the induction energy transmission system in a schematic sectional view,

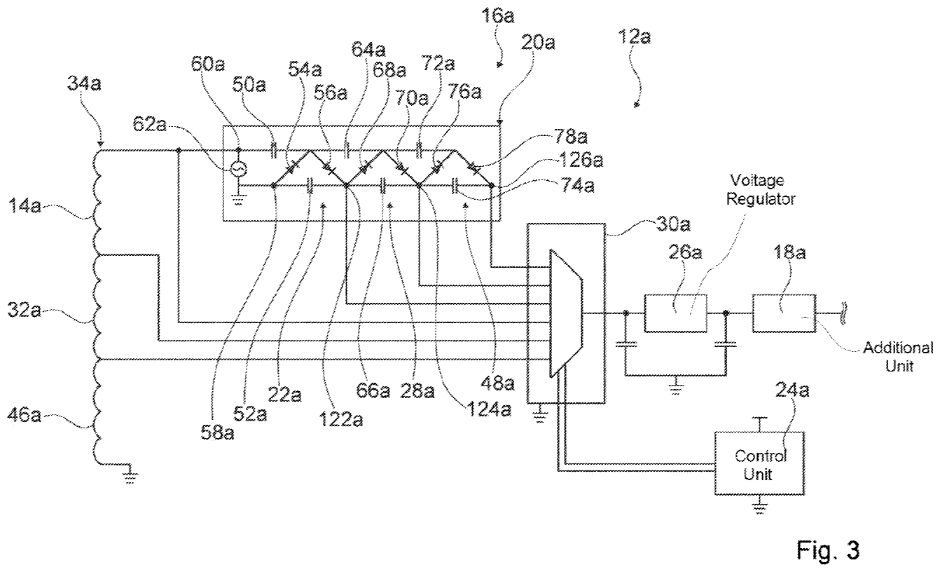

FIG. 3 shows a circuit diagram of the receiving unit with a voltage converter unit in a schematic view,

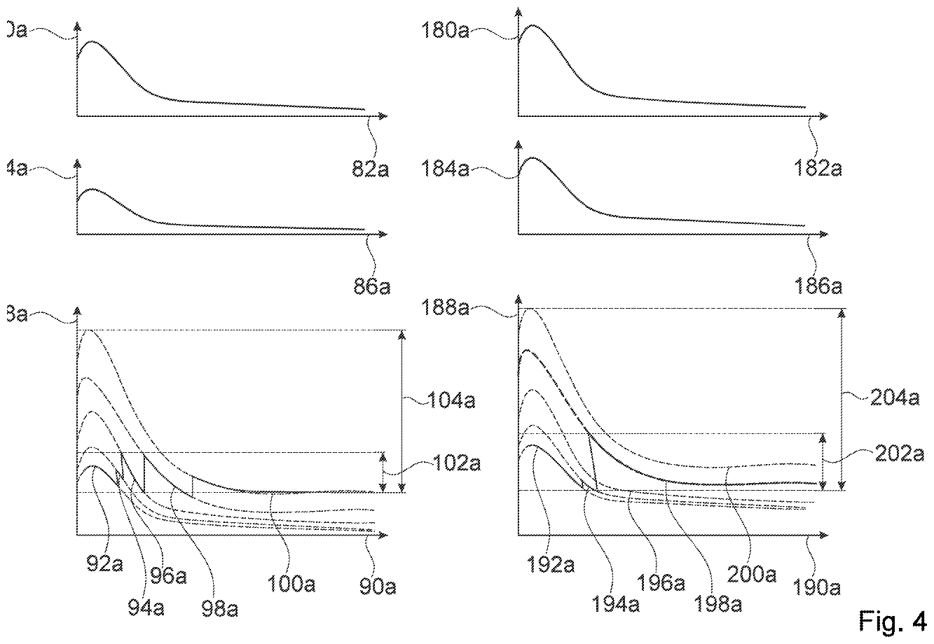

FIG. 4 shows two exemplary activation sequences of the induction energy transmission system in three respective diagrams, in which a power, an electromagnetic field and a voltage are plotted in each case over a frequency, in a schematic view,

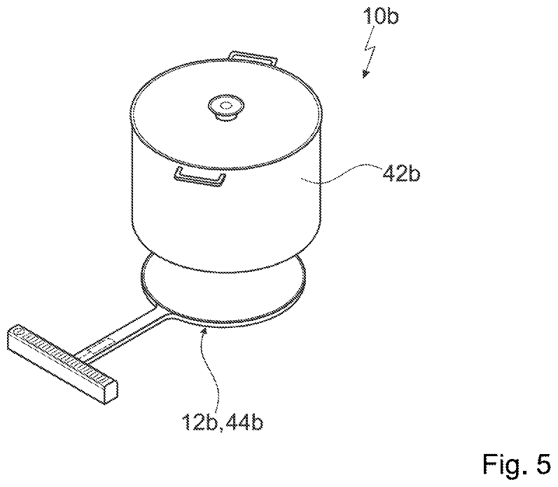

FIG. 5 shows an alternative embodiment of an induction energy transmission system with a receiving unit configured as a support unit in a schematic view and

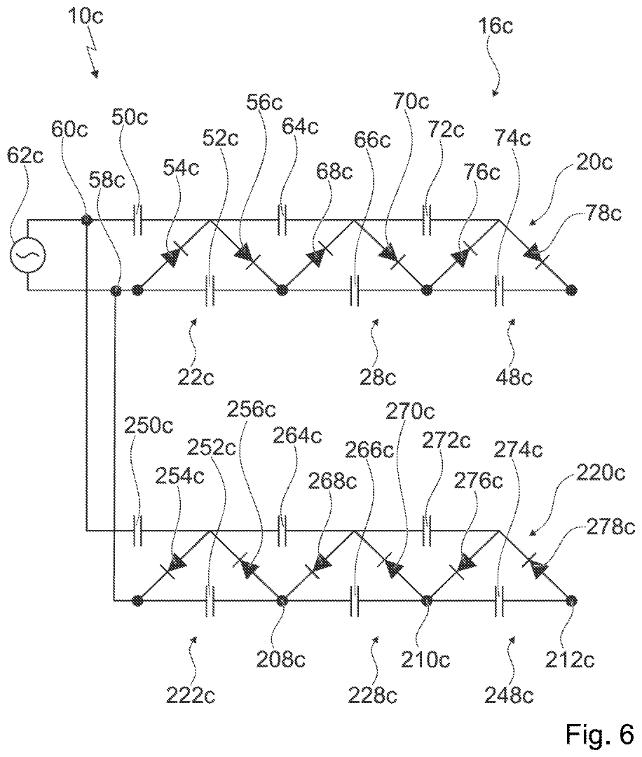

FIG. 6 shows a circuit diagram of a voltage converter unit of a further exemplary embodiment of an induction energy transmission system in a schematic view.

FIG. 1 shows an induction energy transmission system 10a which is configured as an induction cooking system. In the present exemplary embodiment, the induction energy transmission system 10a is configured as an induction hob-type cooking system. The induction energy transmission system 10a has a receiving unit 12a which is configured as an item of cookware 42a.

According to FIG. 2 the receiving unit 12a has a housing unit 110a. The housing unit 110a is configured as an external housing unit and in the operating state forms an external housing of the receiving unit 12a. The receiving unit 12a has a receiving space 120a for receiving food.

The receiving unit 12a has a plurality of receiving induction elements 14a, 32a, 46a. A first receiving induction element 14a, a second receiving induction element 32a and a third receiving induction element 46a of the receiving unit 12a are provided in each case for receiving an inductively provided energy. The first receiving induction element 14a, the second receiving induction element 32a and the third receiving induction element 46a are part of a common secondary coil 34a (see FIG. 3). Additionally, the receiving unit 12a has a further receiving induction element 116a which is part of a further secondary coil 118a and is also provided for receiving an inductively provided energy. Alternatively, the receiving unit 12a could have a larger number of receiving induction elements 14a, 32a, 46a, such as for example at least five, advantageously at least six and preferably a plurality of receiving induction elements 14a, 32a, 46a. In these and the following exemplary embodiments, in each case the three receiving induction elements 14a, 32a, 46a are described by way of example, but any number may be selected and the description transferred, in particular, to a different number of receiving induction elements.

The receiving induction element 14a forms a first coil portion of the secondary coil 34a. The second receiving induction element 32a has the first receiving induction element 14a and additionally a second coil portion of the secondary coil 34a which, in particular, is electrically connected in series with the first coil portion. The third receiving induction element 46a has the first receiving induction element 14a and the second receiving induction element 32a and additionally a third coil portion of the secondary coil 34a which, in particular, is electrically connected in series with the first coil portion and the second coil portion.

In at least one operating state, the receiving induction elements 14a, 32a, 46a supply an additional unit 18a. In the operating state, the receiving induction elements 14a, 32a, 46a are provided for supplying energy to an additional unit 18a. The additional unit 18a is part of the receiving unit 12a.

The additional unit 18a is partially integrated in the housing unit 110a. The additional unit 18a is partially arranged on the housing unit 110a. The additional unit 18a is an electronics unit which is different from a control unit 24a of the receiving unit 12a of the induction energy transmission system 10a.

In the present exemplary embodiment the additional unit 18a has a user interface 106a. The additional unit 18a, and in particular the user interface 106a, have an input unit 108a which is provided for an input of operating parameters. The additional unit 18a, and in particular the user interface 106a, have an output unit 112a which is provided for an output of operating parameters to a user. The additional unit 18a, and in particular the user interface 106a, have a control electronics unit 114a which is provided for processing operating parameters. The input unit 108a and the output unit 112a are partially configured in one piece.

The induction energy transmission system 10a has a supply unit 36a. The supply unit 36a is configured as a cooking appliance 40a and namely as an induction hob. The supply unit 36a is provided to provide energy inductively for heating food located in the receiving space 120a of the receiving unit 12a.

The supply unit 36a has a supply induction element 38a. The supply induction element 38a is provided for providing a magnetic alternating field for the first receiving induction element 14a, the second receiving induction element 32a, the third receiving induction element 46a and the further receiving induction element 116a. In at least one operating state, an energy may be received inductively by the receiving induction elements 14a, 32a, 46a and by the further receiving induction element 116a by the magnetic alternating field provided inductively by the supply induction element 38a. The receiving unit 12a comprises at least one electrical heating element (not shown) which is operated by a part of the energy received by the receiving induction elements 14a, 32a, 46a and is provided for heating at least one food located in the receiving space 120a.

FIG. 3 shows an electrical circuit diagram of the receiving unit 12a in a schematic view. The receiving unit 12a comprises a voltage converter unit 16a which is provided for a conversion of an electrical voltage for supplying energy to the additional unit 18a. The voltage converter unit 16a is provided to convert at least one electrical alternating voltage into at least one electrical direct voltage. The receiving unit 12a comprises the control unit 24a with a voltage regulator 26a. The voltage regulator 26a is provided to adjust at least one supply voltage for the additional unit 18a. The control unit 24a comprises a switching unit 30a. The receiving induction element 14a is connected in an electrically conductive manner to the voltage converter unit 16a. The receiving induction elements 14a, 32a, 46a are connected in an electrically conductive manner in each case via the switching unit 30a to the voltage regulator 26a and the control unit 24a. The receiving induction element 14a is connected in an electrically conductive manner to the voltage converter unit 16a.

The voltage converter unit 16a contains a voltage cascade 20a. The voltage cascade 20a comprises a first stage 22a, a second stage 28a and a third stage 48a. The first stage 22a, the second stage 28a and the third stage 48a in each case are connected in an electrically conductive manner via the switching unit 30a to the voltage regulator 26a and to the control unit 24a. The switching unit 30a controls a suitable stage of the stages 22a, 28a, 48a of the voltage cascade 20a as a function of a supply voltage required by the additional unit 18a.

In the present exemplary embodiment, the voltage converter unit 16a comprises a Cockcroft-Walton circuit. The voltage cascade 20a of the voltage converter unit 16a is configured as a three-stage Cockcroft-Walton circuit voltage cascade with the first stage 22a, the second stage 28a and the third stage 48a. The function of a voltage conversion in the first stage 28a using the voltage cascade 20a of the voltage converter unit 16a is to be described hereinafter, wherein for simplicity an ideal loss-free voltage converter unit 16a is considered hereinafter. The first stage 22a comprises a first capacitor element 50a, a second capacitor element 52a, a first diode element 54a and a second diode element 56a.

With a part of the inductively received energy, the receiving induction element 14a provides an alternating voltage for the voltage converter unit 16a and may be considered as an alternating voltage source 62a. The alternating voltage source 62a has a first connection point 58a and a second connection point 60a. In an operating state, an electrical potential difference, which corresponds to a value of a voltage of the alternating voltage source 62a, is present between the first connection point 58a and the second connection point 60a. During a first half oscillation of a first half period of a first alternating voltage interval, the first connection point 58a is at a reference potential and the second connection point 60a is at a potential of a first electrical polarity. During a second half oscillation of a second half period of the first alternating voltage interval of the alternating voltage source 62a, the first connection point 58a is at a reference potential and the second connection point 60a is at a potential of a second electrical polarity opposing the first electrical polarity. The first diode element 54a of the first stage 22a is connected in an electrically conductive manner with its anode via the first connection point 58a to the alternating voltage source 62a. A first electrode of the first capacitor element 50a of the first stage 22a is connected in an electrically conductive manner via a second connection point 60a to the receiving induction element 14a. The first diode element 54a is connected in an electrically conductive manner with its cathode to a second electrode of the first capacitor element 50a. During the first half oscillation of the first alternating voltage interval, a current of the first electrical polarity flows from the first connection point 58a of the alternating voltage source 62a in the forward direction through the first diode element 54a and charges the first capacitor element 50a. A potential difference is present between the electrodes of the first capacitor element 50a, the value of said potential difference corresponding to the voltage of the alternating voltage source 62a. During the second half oscillation of the first alternating voltage interval, a current of the second electrical polarity flows from the second connection point 60a of the alternating voltage source 62a in the direction of the first capacitor element 50a. During this second half oscillation the first diode element 54a blocks the flow of current of the second polarity in a reverse direction, and the potential of the alternating voltage source 62a and the potential between the electrodes of the first capacitor element 50a are added up. After a first alternating voltage interval, the second electrode of the first capacitor element 50a is at a greater electrical potential, the value thereof corresponding to double the value of the voltage of the alternating voltage source 62a.

The anode of the second diode element 56a is connected in an electrically conductive manner to the second electrode of the first capacitor element 50a. The cathode of the second diode element 56a is connected in an electrically conductive manner to a first electrode of the second capacitor element 52a. A second electrode of the second capacitor element 52a is connected in an electrically conductive manner to the first connection point 58a of the alternating voltage source 62a. During the second half oscillation the second capacitor element 52a is charged to the greater potential of the second electrode of the first capacitor element 50a. The voltage provided by the receiving induction element 14a as an input alternating voltage for the voltage converter unit 16a is converted by the first stage 22a of the voltage cascade 20a into an output direct voltage of a larger value. If the first stage 22a of the voltage cascade 20a is connected in an electrically conductive manner to the switching unit 30a via a third connection point 122, the output direct voltage of the first stage 22a of the voltage converter unit 16a may be tapped for supplying the additional unit 18a. At the third connection point 122a the value of the output direct voltage of the first stage 22a corresponds to double the value of the input alternating voltage of the voltage converter unit 16a.

The second stage 28a has a third capacitor element 64a, a fourth capacitor element 66a, a third diode element 68a and a fourth diode element 70a. The third diode element 68a is connected on the anode side to the second capacitor element 52a of the first stage 22a. The diode elements 68a, 70a and the capacitor elements 64a, 66a of the second stage 28a are connected together in the same manner as the diode elements 54a, 56a and the capacitor elements 50a, 52 of the first stage 22a. If the second stage 28a is connected in an electrically conductive manner via a fourth connection point 124a to the switching unit 30a, the second capacitor element 52a of the first stage 22a may be considered as a voltage source for the second stage 28a. A value of the direct voltage provided by the first stage 22a may be further increased in the second stage 28a, wherein this further increase takes place in a manner similar to the above-described increase by the first stage 22a. At the fourth connection point 124a the output direct voltage of the second stage 28a corresponds to three times the value of the input alternating voltage of the first stage 22a. The third stage 48a has a fifth diode element 76a, a sixth diode element 78a, a fifth capacitor element 72a and a sixth capacitor element 74a which are connected together in a manner similar to the first stage 22a and the second stage 28a. If the third stage 48a is connected via a fifth connection point 126a to the switching unit 30a, a value of the voltage may be further increased by electrical processes corresponding to the stages 22a and 28a. The output direct voltage of the third stage 48a of the voltage cascade 20a corresponds to four times the value of the input alternating voltage of the first stage 22a.

FIG. 4 shows on the left-hand side a first overall view of three diagrams for showing a first exemplary activation sequence of the induction energy transmission system 10a. An electrical power is plotted on an ordinate axis 80a of a first diagram, a frequency is plotted on an abscissa axis 82a of the first diagram. An electromagnetic field is plotted on an ordinate axis 84a of a second diagram, a frequency is plotted on an abscissa axis 86a of the second diagram. An electrical voltage is plotted on an ordinate axis 88a of a third diagram, a frequency is plotted on an abscissa axis 90a of the third diagram. The three diagrams represent a first exemplary activation sequence. A first voltage curve 92a in the third diagram describes a voltage induced in the first receiving induction element 14a. A second voltage curve 94a describes a voltage induced in the second receiving induction element 32a. A third voltage curve 96a describes a voltage induced in the third receiving induction element 46a. A fourth voltage curve 98a describes a voltage which is induced in the third receiving induction element 46a and which is converted by the first stage 22a of the voltage converter unit 16a. A fifth voltage curve 100a describes a voltage which is induced in the third receiving induction element 46a and which is converted by the second stage 28a of the voltage converter unit 16a. In the first exemplary activation sequence of the induction energy transmission system 10a, for supplying energy to the additional unit 18a the control unit 24a activates via the switching unit 30a initially the first receiving induction element 14a, then the second receiving induction element 32a, then the third receiving induction element 46a, subsequently the first stage 22a of the voltage converter unit 16a and finally the second stage 28a of the voltage converter unit 16a (see FIG. 3). By activating a different number of receiving induction elements 14a, 32a and 46a of the common secondary coil 34a and/or by activating the different stages 22a, 28a and 48a, in the operating state the control unit 24a maintains an energy provided for supplying energy to the additional unit 18a within an energy supply voltage interval 102a, which in particular corresponds to an optimal supply voltage of the additional unit 18a.

A further overall view of three further diagrams of a further exemplary activation sequence of the induction energy transmission system 10a is shown on the right-hand side in FIG. 4. An electrical power is plotted on an ordinate axis 180a of a further first diagram, a frequency is plotted on an abscissa axis 182a of the further first diagram. An electromagnetic field is plotted on an ordinate axis 184a of a further second diagram, a frequency is plotted on an abscissa axis 186a of the further second diagram. An electrical voltage is plotted on an ordinate axis 188a of a further third diagram, a frequency is plotted on an abscissa axis 190a of the further third diagram. A further first voltage curve 192a describes a further voltage induced in the first receiving induction element 14a. A further second voltage curve 194a describes a further voltage induced in the second receiving induction element 32a. A further third voltage curve 196a describes a further voltage induced in the third receiving induction element 46a. A further fourth voltage curve 198a describes a further voltage which is induced in the third receiving induction element 46a and which is amplified by the first stage 22a of the voltage converter unit 16a. A further fifth voltage curve 200a describes a further voltage which is induced in the third receiving induction element 46a and which is amplified by the second stage 28a of the voltage converter unit 16a. In the further exemplary activation sequence of the induction energy transmission system 10a, for supplying energy to the additional unit 18a the control unit 24a activates via the switching unit 30a initially the first receiving induction element 14a, then the third receiving induction element 46a and subsequently the first stage 22a of the voltage converter unit 16a, in order to maintain the energy provided for supplying energy to the additional unit 18a within a further energy supply voltage interval 202.

The voltage intervals 104a and 204a are shown in the third diagram and the further third diagram in comparison with the energy supply voltage intervals 102a and 202a, in the case of a direct activation of the third stage 48a by the control unit 24a. It may be identified that in each case the voltage intervals 104a and 204a in both examples shown have a substantially greater amplitude than the energy supply voltage intervals 102a and 202a and thus, in particular, this would result in greater stress on the electronic and/or electrical objects of the receiving unit 12a, in particular of the voltage regulator 26a.

In a method for operating the induction energy transmission system 10a, the at least one receiving induction element 14a receives an inductively provided energy, wherein an electrical voltage of the receiving induction element 14a is converted for supplying energy to the at least one additional unit 18a. In the present case, the supply induction element 38a provides energy inductively to be received by the at least one receiving induction element 14a (see FIG. 2). An electrical voltage of the receiving induction element 14a is converted by the voltage converter unit 16a for supplying energy to the additional unit 18a (see FIG. 3).

In FIGS. 5 and 6 two further exemplary embodiments of the invention are shown. The following descriptions are substantially limited to the differences between the exemplary embodiments, wherein relative to components, features and functions remaining the same, reference may be made to the description of the exemplary embodiment of FIGS. 1 to 4. For differentiating between the exemplary embodiments, the letter a is replaced in the reference characters of the exemplary embodiment in FIGS. 1 to 4 by the letters b and c in the reference characters of the exemplary embodiments of FIGS. 5 and 6. Relative to components which are denoted the same, in particular relative to components with the same reference characters, in principle reference may also be made to the drawings and/or the description of the exemplary embodiment of FIGS. 1 to 4.

FIG. 5 shows a further exemplary embodiment of an induction energy transmission system 10a. A receiving unit 12b of the induction energy transmission system 10b is configured as a support unit 44b for positioning an item of cookware 42b. Apart from an inductive heating, the receiving unit 12b has the functionality of the receiving unit 12a of the previous exemplary embodiment. In the present case the inductive heating takes place directly in a cookware base of the item of cookware 42b.

FIG. 6 shows an electrical circuit diagram of a further alternative exemplary embodiment of an induction energy transmission system 10c. The induction energy transmission system 10c of the present exemplary embodiment is configured in a manner which is substantially identical to the induction energy transmission system 10a of the first exemplary embodiment and differs only relative to a voltage converter unit 16c of the induction energy transmission system 10c. The voltage converter unit 16c is provided to convert at least one electrical alternating voltage into an electrical direct voltage of a first electrical polarity and into at least one further electrical direct voltage with a second electrical polarity opposing the first electrical polarity.

The voltage converter unit 16c comprises a voltage cascade 20c and a further voltage cascade 220c. The voltage cascade 20c comprises a first stage 22c with the diode elements 54c, 56c and the capacitor elements 50c, 52c; a second stage 28c with the diode elements 68c, 70c and the capacitor elements 64c, 66c and a third stage 48c with the diode elements 76c, 78c and the capacitor elements 72c, 74c. The construction and mode of operation of the voltage cascade 20c correspond to the above-described view of the voltage cascade 20a of FIG. 3. The further voltage cascade 220c is constructed symmetrically to the voltage cascade 20c. The further voltage cascade 220c comprises a further first stage 222c with the further diode elements 254c, 256c and the further capacitor elements 250c, 252c; a further second stage 228c with the further diode elements 268c, 270c and the further capacitor elements 264c, 266c and a further third stage 248c with the further diode elements 276c, 278c and the further capacitor elements 272c and 274c. The elements of the further voltage cascade 220c are arranged relative to one another in a manner which is at least substantially the same as the elements of the voltage cascade 20c, wherein the respective forward directions of the diode elements 254c, 256c, 268c, 270c, 276c, 278c of the further voltage cascade 220c are reversed relative to the respective forward directions of the diode elements 54c, 56c, 68c, 70c, 76c, 78c of the voltage cascade 20c. For example, a current flows through the first diode element 54c in the first voltage cascade 20c during a first half oscillation of a half period of an alternating voltage interval of an alternating voltage source 62c which is connected via the connection points 58c and 60c to the voltage cascades 20c and 220c, and charges the first capacitor element 50c, while during this first half oscillation the further first diode element 254c of the further voltage cascade 220c blocks a flow of current in the direction of the further first capacitor element 250c. As a result, the electrical processes in the voltage cascade 20c and in the further voltage cascade 220 are temporally offset in each case by half a period. The further first stage 222c of the further voltage cascade 220c may be connected via a further third connection point 208c, the further second stage 228c may be connected via a further fourth connection point 210c and the further third stage 248c may be connected via a further fifth connection point 212c to a switching unit (not shown) of the induction energy transmission system 10c. Depending on the switching state, a further electrical direct voltage converted by the voltage converter unit 16d, with a second electrical polarity opposing the first electrical polarity of the direct voltage converted by the first voltage cascade 20c, may be tapped at the further connection points 208c, 210c and 212c. In the present case, this second polarity corresponds to a negative electrical polarity.

### LIST OF REFERENCE CHARACTERS

10 Induction energy transmission system
12 Receiving unit
14 Receiving induction element
16 Voltage converter unit
18 Additional unit
20 Voltage cascade
22 First stage
24 Control unit
26 Voltage regulator
28 Second stage
30 Switching unit
32 Second receiving induction element
34 Secondary coil
36 Supply unit
38 Supply induction element
40 Cooking appliance
42 Item of cookware
44 Support unit
46 Third receiving induction element
48 Third stage
50 First capacitor element
52 Second capacitor element
54 First diode element
56 Second diode element
58 First connection point
60 Second connection point
62 Alternating voltage source
64 Third capacitor element
66 Fourth capacitor element
68 Third diode element
70 Fourth diode element
72 Fifth capacitor element
74 Sixth capacitor element
76 Fifth diode element
78 Sixth diode element
80 Ordinate axis
82 Abscissa axis
84 Ordinate axis
86 Abscissa axis
88 Ordinate axis
90 Abscissa axis
92 First voltage curve
94 Second voltage curve
96 Third voltage curve
98 Fourth voltage curve
100 Fifth voltage curve
102 Energy supply voltage interval
104 Voltage interval
106 User interface
108 Input unit
110 Housing unit
112 Output unit
114 Control electronics unit
116 Further receiving induction element
118 Further secondary coil
120 Receiving space
122 Third connection point
124 Fourth connection point
126 Fifth connection point
180 Ordinate axis
182 Abscissa axis
184 Ordinate axis
186 Abscissa axis
188 Ordinate axis
190 Abscissa axis
192 Further first voltage curve
194 Further second voltage curve
196 Further third voltage curve
198 Further fourth voltage curve
200 Further fifth voltage curve
202 Further energy supply voltage interval
204 Further voltage interval
208 Further third connection point
210 Further fourth connection point
212 Further fifth connection point
220 Further voltage cascade
222 Further first stage
228 Further second stage
248 Further third stage
250 Further first capacitor element
252 Further second capacitor element
254 Further first diode element
256 Further second diode element
264 Further third capacitor element
266 Further fourth capacitor element
268 Further third diode element
270 Further fourth diode element
272 Further fifth capacitor element
274 Further sixth capacitor element
276 Further fifth diode element
278 Further sixth diode element

1-14. (canceled)

15. An induction energy transmission system, in particular an induction cooking system, said induction energy transmission system comprising a receiving unit comprising a first receiving induction element for receiving an inductively provided energy, and a voltage converter unit connected to the first receiving induction element and configured to convert an electrical voltage of the first receiving induction element for supply of energy to an additional unit.

16. The induction energy transmission system of claim 15, wherein the voltage converter unit comprises a voltage cascade with at least one stage.

17. The induction energy transmission system of claim 15, wherein the receiving unit comprises a control unit which includes a voltage regulator configured to adjust a supply voltage for the additional unit.

18. The induction energy transmission system of claim 16, wherein the voltage cascade includes a plurality of stages for conversion of the electrical voltage, said receiving unit comprising a control unit which includes a switching unit configured to activate a corresponding one of the stages of the voltage cascade as a function of a supply voltage required by the additional unit.

19. The induction energy transmission system of claim 15, wherein the voltage converter unit is configured to convert an electrical alternating voltage into a first electrical direct voltage.

20. The induction energy transmission system of claim 19, wherein the voltage converter unit is configured to convert the electrical alternating voltage into a second electrical direct voltage with a polarity opposing a polarity of the first electrical direct voltage.

21. The induction energy transmission system of claim 15, wherein the voltage converter unit comprises a Cockcroft-Walton circuit.

22. The induction energy transmission system of claim 15, wherein the receiving unit includes a second receiving induction element which is part of a common secondary coil with the first receiving induction element.

23. The induction energy transmission system of claim 15, further comprising a supply unit comprises a supply induction element configured to provide a magnetic alternating field for the first receiving induction element.

24. The induction energy transmission system of claim 23, wherein the supply unit is configured as a cooking appliance.

25. The induction energy transmission system of claim 15, wherein the receiving unit is configured as an item of cookware.

26. The induction energy transmission system of claim 15, wherein the receiving unit is configured as a support unit for positioning an item of cookware.

27. An item of cookware or support unit for positioning an item of cookware, comprising an induction energy transmission system, said induction energy transmission system comprising a receiving unit which includes a first receiving induction element for receiving an inductively provided energy, and a voltage converter unit connected to the first receiving induction element and configured to convert an electrical voltage of the first receiving induction element for supply of energy to an additional unit.

28. The item of cookware or support unit of claim 27, wherein the receiving unit comprises a control unit which includes a voltage regulator configured to adjust a supply voltage for the additional unit.

29. The item of cookware or support unit of claim 27, wherein the voltage converter unit comprises a voltage cascade including a plurality of stages for conversion of the electrical voltage, said receiving unit comprising a control unit which includes a switching unit configured to activate a corresponding one of the stages of the voltage cascade as a function of a supply voltage required by the additional unit.

30. The item of cookware or support unit of claim 27, wherein the voltage converter unit is configured to convert an electrical alternating voltage into a first electrical direct voltage.

31. The item of cookware or support unit of claim 30, wherein the voltage converter unit is configured to convert the electrical alternating voltage into a second electrical direct voltage with a polarity opposing a polarity of the first electrical direct voltage.

32. The item of cookware or support unit of claim 27, wherein the receiving unit includes a second receiving induction element which is part of a common secondary coil with the first receiving induction element.

33. The item of cookware or support unit of claim 27, wherein the induction energy transmission system comprises a supply unit which includes a supply induction element configured to provide a magnetic alternating field for the first receiving induction element.

34. A method for operating an induction energy transmission system which includes a receiving induction element which in an operating state receives inductively provided energy, said method comprising converting an electrical voltage of the receiving induction element for supplying energy to an additional unit.
